(19) United States
(12) Patent Application Publication
(10) Pub. No.: US 2005/0081363 A1
(43) Pub. Date: Apr. 21, 2005

(54) Apparatus and method for nanoscale and microscale mechanical machining and processing

(76) Inventors: Ajay P. Malshe, Fayetteville, AR (US); Chad O'Neal, Ruston, LA (US)

Correspondence Address: HEAD, JOHNSON & KACHIGIAN, 228 W 17TH PLACE, TULSA, OK, 74119, US

(21) Appl. No.: 10/500,432

(22) PCT Filed: Jan. 2, 2003
(86) PCT No.: PCT/US03/00096

Related U.S. Application Data
(60) Provisional application No. 60/345,264, filed on Jan. 3, 2002.

(51) Int. Cl. B23P 13/04; B23C 1/00

(52) U.S. Cl. 29/558; 409/132; 408/1 R; 409/140

(57) ABSTRACT

A microscale device provides for a nanoscale machining. A tool, similar to probes used in atomic force microscopy is attached to a micro-load gear and is powered by a micromotor. This very small tool allows a variety of nanostructures to be fabricated on a variety of substrates.

### CROSS-REFERENCE TO RELATED APPLICATIONS

This application claims priority to U.S. Provisional Patent Application No. 60/345,264 filed on Jan. 3, 2002.

### BACKGROUND OF THE INVENTION

1. Field of the Invention

The present invention relates to an apparatus and method for micro-scale machining and processing. Specifically, the present invention comprises a nanotool, a nanotool holder, and a means for actuating the nanotool. The rotational motion allows the tool to have a drilling or milling action. The invention also comprises a nanotool capable of linear, back and forth motion.

2. Prior Art

Despite the vast scope of benefits of nano science and technology, the field today remains in an exploratory phase. The large choices of materials, spectrum of applications, requirements of designing, synthesis and processing tools and unknowns about the behavior of nano systems make this field amorphous but at the same time very exciting for scientists and engineers. One of the most important areas, which will impact all sections of nanotechnology is the design and development of nanotools for nano machining and manufacturing.

From SMART tools to micro-electromechanical systems (MEMS) and nano-electromechanical systems (NEMS), SMART cards to cell phones, micro/nano satellites to space system-on-chip, quantum computing to DNA computing, research on nano and micro systems engineering is leading to changes in the way we live. Such miniaturized systems are desired for various applications as components in automobiles, aerospace vehicles, bio-medicine, informatics hardware, high performance computing, electronics, etc. The research and progress in nano-manufacturing harbors on the platform of micro and meso tools and subsystems which are then interfaced to the macroscopic world. Thus the research in nano as well as micro/meso systems enables important conventional requirements such as efficiency, portability, robustness, programmability, cost efficiency, durability, and new set of requirements such as configurability, evolutionary and adaptability, and intelligent decision making abilities, realtime interacting and self powered. The last century has observed inception and impressive growth of microelectronics technology and related IC based systems. But it is important to remember that the challenges of the present century are not only to continue to enjoy the benefits of microelectronics and IC technology but also to explore the avenues for manufacturing multi-signal (electrical, optical, chemical, biological, etc.)/multifunctional integrated systems at nano and micro scales. One of the major trends in nano integrated micro technology is the attraction and desire to integrate nano/micro—bio—info. It is imperative that the future of nano science and engineering relies significantly on the development of fundamental understanding of sub-system and system behavior as well as ability to design, synthesize, process, measure and manufacture reproducible sub-systems and systems at nano scale. Advanced techniques to write (bottom-up) or machine (top-down), using natural or intentional approaches in dry ambient is extremely important and timely.

The development of nanotechnology will depend on the ability of researchers to efficiently manufacture structures <300 nm for biological as well as abiological applications. Traditional, photolithography processes used to fabricate integrated circuits can be modified to produce nanometer-scale structures, but the modifications would be technically difficult and significantly expensive. The tools and processes for nano manufacturing can be classified in various ways, but predominantly one can classify them as a wet versus dry process or natural versus intentional organization or bottom-up (carve out or add aggregates or molecules to a surface) or top-down (assemble atoms or molecules into nanostructures) fabrication.

There are a number of methods that have been used to fabricate nanostructures. While many of these techniques are well suited for fabricating mircrostructures, such as microchips, they are not well suited for formation of nanostructures. What existing technology currently lacks are mechanical nano construction techniques. Those skilled in the art of nano construction techniques have in the past rejected the idea of using more classic, mechanical methods to form nanostructure. Instead, those skilled in the art have sought to develop very complex nano construction techniques. However, mechanical tools are generally accurate, efficient and allow high through put. It is, therefore, desirable to provide nano construction techniques that utilize mechanical tools, instead of the more complicated techniques that utilize photolithography, lasers, ion beams and the like.

In photolithography one first makes the equivalent of a photographic negative containing the pattern required for some part of a microchip's circuitry. This negative, which is called the mask or master, is then used to copy the pattern into the metals and semiconductors of a microchip. The process separates into two stages: the preparation of the mask and the use of the mask to manufacture replicas. To make a mask for a part of a computer chip, a manufacturer first designs the circuitry pattern on a conveniently large scale and converts it into a pattern of opaque metallic film (usually chromium) on a transparent plate (usually glass or silica). Photolithography then reduces the size of the pattern in a process analogous to that used in a photographic darkroom. A beam of light (typically ultraviolet light, UV from a mercury arc lamp) shines through the chromium mask, then passes through a lens that focuses the image onto a photosensitive coating of organic polymer (called the photoresist) on the surface of a silicon wafer. The parts of the photoresist struck by the light can be selectively removed, exposing parts of the silicon wafer in a way that replicates the original pattern. The main limitations are (i) the shortest wavelength of ultraviolet light currently used in production processes is about 250 nanometers, although laboratory research scale smaller wavelengths are being successfully experimented; (2) it is also very expensive to do so for small numbers of parts.

Another method being developed is electron beam lithography. In this method, the circuitry pattern is written on a thin polymer film with a beam of electrons. An electron beam does not diffract at atomic scales, so it does not cause blurring of the edges of features. Researchers have used the technique to write lines with widths of only a few nanometers in a layer of photoresist on a silicon substrate. The electron-beam instruments currently available, however, are very expensive and impractical for large-scale manufacturing.

Another option is lithography using x-rays with wavelengths between 0.1 and 10 nanometers or extreme ultraviolet light with wavelengths between 10 and 70 nanometers. Because these forms of radiation have much shorter wavelengths than the ultraviolet light currently used in photolithography, they minimize the blurring caused by diffraction. These technologies face their own set of problems, however, conventional lenses are not transparent to extreme ultraviolet light and do not focus x-rays. Furthermore, the energetic radiation rapidly damages many of the materials used in masks and lenses. But the microelectronics industry clearly would prefer to make advanced chips using extensions of familiar technology, so these methods are being actively developed.

Instead of using light and electrons, some research groups have employed mechanical processes that are familiar in everyday life: printing, stamping, molding and embossing. The techniques are called soft lithography because the tool they have in common is a block of polydimethylsiloxane (PDMS). To carry out reproduction using soft lithography, one first makes a mold or a stamp. The most prevalent procedure is to use photolithography or electronbeam lithography to produce a pattern in a layer of photoresist on the surface of a silicon wafer. Then a chemical precursor to PDMS-a freeflowing liquid is poured over the basrelief master and cured into the rubbery solid. The result is a PDMS stamp that matches the original pattern with astonishing fidelity: the stamp reproduces features from the master as small as a few nanometers. Although the creation of a finely detailed bas-relief master is expensive because it requires electron-beam lithography or other advanced techniques, copying the pattern on PDMS stamps is cheap and easy.

Those skilled in the art will appreciate that there are still other techniques, such as micromolding, that are currently being investigated. It will also be appreciated that these other techniqes currently present the same obstacles of impracticality and high cost associated with the procedures described above. The most successful tools, described below, are used mainly to study and measure the structures of nano-scale samples.

The scanning tunneling microscope (STM) detects small currents that pass between the microscope's tip and the sample being observed, allowing researchers to “see” substances at the scale of individual atoms. The success of the STM led to the development of other scanning probe devices, including the atomic force microscope (AFM). The AFM can detect variations in vertical surface topography that are smaller than the dimensions of the probe.

Scanning probe devices can do more than observe the atomic world, they can also be used to create nanostructures. The tip on the AFM can be used to physically move nanoparticles around on surfaces and to arrange them in patterns. It can also be used to make scratches in a surface (or more commonly, in monolayer films of atoms or molecules that coat the surface). Similarly, if researchers increase the currents flowing from the tip of the STM, the microscope becomes a very small source for an electron beam, which can be used to write nanometer-scale patterns. The STM tip can also push individual atoms around on a surface to build rings and wires that are only one atom wide.

An intriguing new scanning probe fabrication method is called dip-pen lithography. This technique works much like a goose-feather pen. The tip of the AFM is coated with a thin film of thiol molecules that are insoluble in water but react with a gold surface. The drop of water acts as a bridge over which the thiol molecules migrate from the tip to the gold surface, where they are fixed. Researchers have used this procedure to write lines a few nanometers across.

The STM platform has been used in various top-down modes for various known and anticipated applications and the following is a synopsis from current literature in light of the proposed SOAC.

Micro-actuators combined with nanometer-scale tips to manipulate and control things on a small scale. These micro-instruments or micro-robots are made using micro-machining technology, atomic probes or micro-scanning tunneling microscopes (micro-STMs) that were micro-machined from single crystal silicon have been fabricated. One micro-STM measures a few millimeters on a side, and a smaller micro-STM measures a few hundred micrometers on a side. Each micro-STM includes integrated x-y capacitive micro-actuators made of electrostatic comb-like structures, an integrated tunneling tip mounted on a ‘teeter-totter’ torsional z motion-micro-actuator, microstructural supports and springs, and wiring integrated on the suspended microstructures to supply power to the tip and the micro-actuators. The larger STM was used to image 300 nm metal lines on a ‘silicon-chip-sample’ placed on top of the micro-STM and supported by integrated SCS posts. The building blocks used to make these ‘micro-STMs’—the micro-actuators, the tips and probes, the silicon micro-machining processes, the micro-system architecture, and the design methods are the basic components required to build micromanipulators and micro-robots for nanometer-scale manipulation.

A new atomic force microscope (AFM)-based data storage concept, called the “Millipede,” has a potentially ultrahigh density, terabit capacity, small form factor, and high data rate. With this newtechnique, 30-40 nm-sized bit indentations of similar pitch size have been made by a single cantilever/tip in a thin (50-nm) polymethylmethacrylate (PMMA) layer, resulting in a data storage density of 400-500 Gb/in². High data rates are achieved by parallel operation of large two-dimensional (2D) AFM arrays that have been batch-fabricated by silicon surface-micromachining techniques. The very large scale integration (VLSI) of micro/nanomechanical devices (cantilevers/tips) on a single chip leads to the largest and densest 2D array of 32×32 (1024) AFM cantilevers with integrated write/read storage functionality ever built. Time-multiplexed electronics control the write/read storage cycles for parallel operation of the Millipede array chip. Initial areal densities of 100-200 Gb/in² have been achieved with the 32×32 array chip.

A novel device composed of twin nano probes has recently been fabricated. The size of the probes are 200 nm high, 280 nm wide and 5 μm long, which are formed by silicon anisotropic etching. The initial gap was about 400 nm between the probes which became 84 nm when 101 mW input power was given to the thermal expansion micro actuators integrated with the probes. Precise motion down to 4 nm/mW was confirmed by simultaneous TEM observation.

In the last two decades, significant progress has made in the field of sensing and actuating micro electro mechanical systems (MEMS). Successful and reliable implementation of various MEMS actuation mechanisms such as electrostatic comb drives, thermal actuators, and microscale steam engines have been demonstrated in diverse range of applications such as flip mirror, cam and its application to micro engines. Those skilled in the art will appreciate that a number of micro-scale motors have been developed and applied to a few devices. However, micro-scale machines capable of fabricating, machining and processing small scale devices have not been developed. A strong need exists for a micro-scale device capable of quickly, accurately, precisely and repeatably fabricating small nano- and micro-scale devices having electronic circuitry, vias, channels and pores.

### SUMMARY OF THE INVENTION

Today's version of scanning probe technique and its spin offs described above can not perform drilling, deposition of materials, cutting, scraping, orapplying heator lasers and related machining operations as it does not provide dynamic, rotating or oscillating STM tips, we refer to as nanotools here. Unlike any of the above, the novelty of this proposal is in the designing and development of such a nano mechanical machining system-on-a-chip (SOAC) having a nanotool, a nanotool holder and their actuation. Specifically, the invention includes a dynamic machining nanotool, capable of performing operations such as drilling, deburring, lasing, heating, cutting depositing materials, etc. in top-down or bottom-up manufacturing. This novel SOAC is adaptable to today's AFM/STM machine platform and will allow rotational motion to the nanotool. In this context it is important to mention that these tips can be further machined to the desired geometry by focused ion beam (FIB), femtosecond laser, or electron beam machining. These facts further enhance the importance and the potential of the present invention.

The tools for nano machining can be classified in various ways, but predominantly one can classify them as (1) wet versus dry process, (2) natural versus intentional organization, and (3) bottom-up or top-down fabrication. The present invention involves dry processing for intentional organization in either a top-down or bottom-up fabrication approach.

The purpose of the present invention is to provide a nano mechanical machining SOAC adaptable to today's AFM/STM machine for writing nano features like vias, channels, steps, electronic circuitry, pores and the like for a broad range of applications. MEMS technology may be used to design and develop machining tools for patterning nanoscale (50-300 nm) features. The proposed innovation is critical and timely. The present invention will impact security, semiconductor, optical, bio, pharmaceutical, etc. application areas.

The actuator for the rotational tool of one embodiment of the present invention is a micro-scale motor that is connected to a micro-scale gear which it rotates. Attached to either the top or bottom of the micro-gear is a micro- or nano-scale tool. The tool is aligned with the pivotal axis of the micro-gear such that it rotates with the gear. This allows drilling, deburring, milling, etc. on both a nanometer and micrometer scale. Those skilled in the art will appreciate that microfabrication is greatly simplified by use of this rotating tool. The following table demonstrates the advantages that the present invention holds over other methods of nanofabrication.

| Nano Fabrication | | |
|---|---|---|
| Techniques | | |
| (for top-down approach) | Advantages | Disadvantages |
| Photolithography | Already used in application for | Expensive and technically |
| | microelectronic applications. | difficult. Application of electron |
| | Technique can be further tailored | beans is costly and slow. X-rays |
| | to produce nanometer scale | and extreme UV light can |
| | structures by using electron beans, | damage the equipment used in |
| | x-rays or extreme UV | the process. |
| Soft Lithography | It is an inexpensive approach to | In the existing form, it is not |
| | reproduce pattern created by | implementable for multilayer |
| | electron beam lithography or | structures like microelectronic |
| | other related techniques. It can be | devices. |
| | implemented inexpensively at | |
| | laboratory scale. | |
| Scanning Probe | In the existing form, it can be | In the existing form, the method |
| Method | applied for indentation and | is slow and limited to specialized |
| | patterning/manipulation at | devices. Though the work for |
| | atomic and particulate scale. | writing and reading using |
| | | multiple tips by Vettiger, et al. |
| | | demonstrates that these are NOT |
| | | the fundamental limits of the |
| | | method. |
| Nano Machining | It can be further applied for nano | |
| Method | drilling and related machining | |
| | operation for applications like | |
| | writing nanovias, mesa/step | |
| | structures, etc. Significantly | |
| | extending the scope of today's | |
| | SPM platform. Actuation using | |
| | MEMS technique at >10,000 + rpm | |
| | is attractive for the objective | |

### BRIEF DESCRIPTION OF THE DRAWINGS

FIG. 1 shows a diagrammatic top plan view of a micromotor of the present invention;

FIG. 2 is a perspective view of a drive gear attached to a micromotor as shown in FIG. 1;

FIG. 3 shows the drive gear of a micromotor having an adjacent load gear of the present invention;

FIG. 4 is a diagrammatic cross-sectional view of the load gear and nanotool of the present invention;

FIG. 5 is a perspective view of an alternative embodiment of the present invention;

FIG. 6 is a perspective view of an alternative embodiment of the present invention;

FIG. 7 is a diagrammatic cross-sectional view of an alternative nanotool for use in the present invention;

FIG. 8 is a diagrammatic cross-sectional view of an alternative nanotool for use in the present invention;

FIG. 9 is a diagrammatic cross-sectional view of an alternative nanotool for use in the present invention;

FIG. 10 is a diagrammatic cross-sectional view of an alternative nanotool for use in the present invention; and

FIG. 11 is a diagrammatic top plan view of an alternative embodiment of the present invention.

### DETAILED DESCRIPTION OF THE PREFERRED EMBODIMENTS

The embodiments discussed herein are merely illustrative of specific manners in which to make and use the invention and are not to be interpreted as limiting the scope of the instant invention.

While the invention has been described with a certain degree of particularity, it is to be noted that many modifications may be made in the details of the invention's construction and the arrangement of its components without departing from the spirit and scope of this disclosure. It is understood that the invention is not limited to the embodiments set forth herein for purposes of exemplification.

The present invention is a novel combination of structures and devices used at nano and micro scales. Atomic force microscopy (AFM) utilizes extremely small silicon tips that are micrometers long and nanometers wide. A variety of techniques as described above in the background may be used to form these tips. In the present invention, the same techniques are utilized to form rotational tips, but not on the end of a silicon cantilever as used in AFM. In the present invention, these tips are placed in the center of a load gear and rotational force is applied to them. This allows these tips to perform a variety of functions on various substrates. Until now, AFM tips have only been suitable for use in nanoindentation of various substrates. This has greatly limited their utility in forming nanostructures. One of the key features of the present invention, adding rotational motion to an AFM tip, creates a nanotool capable of performing a variety of functions on a nanometer scale. This tool may be utilized to rapidly and accurately drill into substrates, forming vias, channels, reservoirs, microfluidic channels and other structural features. In addition, the nanotools may be formed in a variety of shapes. This further enhances their utility by providing nanotools capable of depositing material in order to form electrical circuits as well as add structural features such as molecular walls and other similar features. Other geometries of the nanotool allow it to polish or deburr a substrate. Unlike other nanoconstruction techniques, the present invention mechanically operates upon a substrate in order to form well defined nanostructures. This avoids problems in the prior art that limit the size of structures they may form. Photolithography, because of the wavelength restrictions of UV light, are incapable of forming nanostructures of the same small scale that the nanotools of the present invention may accurately construct. X-ray and electron beam lithographic techniques are slow and expensive. The present invention is fast, efficient and low cost. This, combined with its accuracy, makes it superior to other techniques known in the art. In addition, multiple nanotools may be arranged in three dimensional designs such that a substrate may be worked on from multiple directions. The present invention may also be used in a construction line type of process. Several nanotools may be aligned in a row and substrates may move on a conveyor belt or by other means from one to the other having various nano structures formed on them. This provides for high through put and low cost. Additionally, the preferred materials and equipment used to create these nanostructures is extremely durable providing a long life and reliability for the nano tools. The present invention is well suited for creating nanostructures such as system-on-a-chip (SOAC), lab-on-a-chip (LOAC), microfluidic and nanofluidic systems and nanocircuitry. Those skilled in the art will appreciate that there is a strong need for the nanoconstruction techniques provided by the present invention.

In the specification, the following terms are intended to have the following general definitions.

“Nanotool” refers generally to a device that is generally from two-ten μm long and less than 400 nm wide. In the embodiment described below, polysilicon is etched to form a pointed nanotool. However, the term nanotool refers to a variety of other geometries as will also be disclosed. Generally, they all have a relatively high aspect ratio at or about 10:1. A variety of materials may be used to form the nano tool. Polysilicon, especially when doped by a focused ion beam (FIB), is especially suited because these materials are commonly used for AFM and are well known to those skilled in the art. Nanotools are capable of both nanoscale and microscale mechanical machining.

“Micromotor” refers generally to any microscale motor capable of applying rotational motion to a drive gear. In a particular embodiment disclosed below, Sandia National Laboratorie's SUMMiT® micromotor is used. The SUMMiT® micromotors are comprised of a drive gear that is rotated by means of drive arms attached to electrostatic comb actuators. This type of micromotor is well studied and commercially available, therefore it is generally preferred. However, those skilled in the art will appreciate that there are a variety of micromotors of similar scale capable of providing similar RPM and torque to a drive gear. For example, Sandia manufactures a variety of micromotors, including micro steam engines and circular motors.

“Drive Gear” refers generally to a gear that is part of or attached to a micro motor and is capable of conveying rotational motion to other gears interlocked with it. It is generally the gear that applies rotational force so as to actuate a nanotool.

“Load Gear” refers generally to a gear that is rotationally actuated by a drive gear. In this particular invention, a nanotool is attached to the load gear such that it is aligned with the axis of the load gear and rotates when the load gear is actuated by a drive gear.

“Substrate” refers generally to a chip or other object upon which a nano structure is constructed by means of a nano tool. Typically, a substrate will be a chip comprised of silicon, and/or silicon oxide and having a very thin coating of GaAs. However, those skilled in the art will appreciate that a variety of other substrates are suitable.

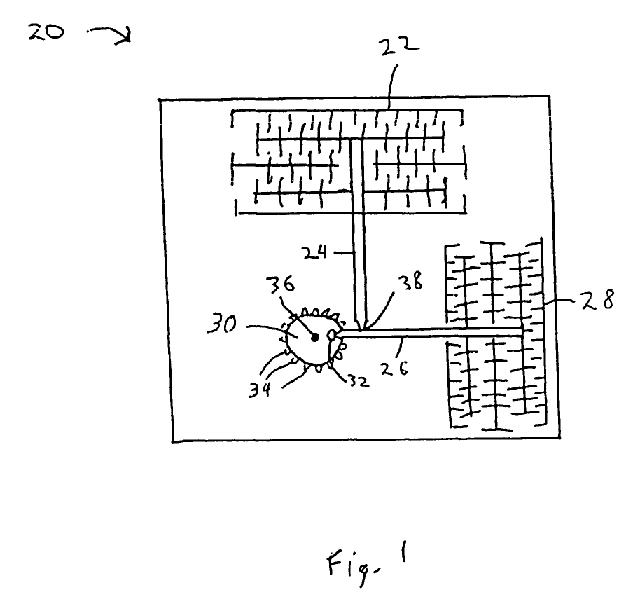

FIG. 1 shows a schematic diagram of a micromotor suitable for the present invention and of the design used by Sandia National Laboratories. Micromotor 20 is comprised of two electrostatic comb actuators 22 and 28. Drive arm 26, actuated by comb drive 28, is attached to drive gear 30 at connection point 32. Cam rod 24 is actuated by comb drive 22. As drive arm 26 oscillates, cam rod 24, which is connected to drive rod 26 at connection point 38, oscillates causing drive arm 26 to apply circular motion to connection point 32 thereby causing drive gear 30 to rotate. Drive gear 30 has about its circumference a series of teeth 34 that allow it to actuate other gears.

The micromotor shown in FIG. 1 is a typical micromotor well known to those skilled in the art, and produced commercially. Although a variety of uses have been found for such micromotors, the present invention is the only one that has used it to apply rotational motion to a nano tool capable of forming nanostructures on a substrate. Furthermore, those skilled in the art will appreciate that the micromotor shown in FIG. 1 is only one of many micromotors commercially available. Sandia National Laboratories and other entities produce a variety of micromotors capable of conferring rotational motion.

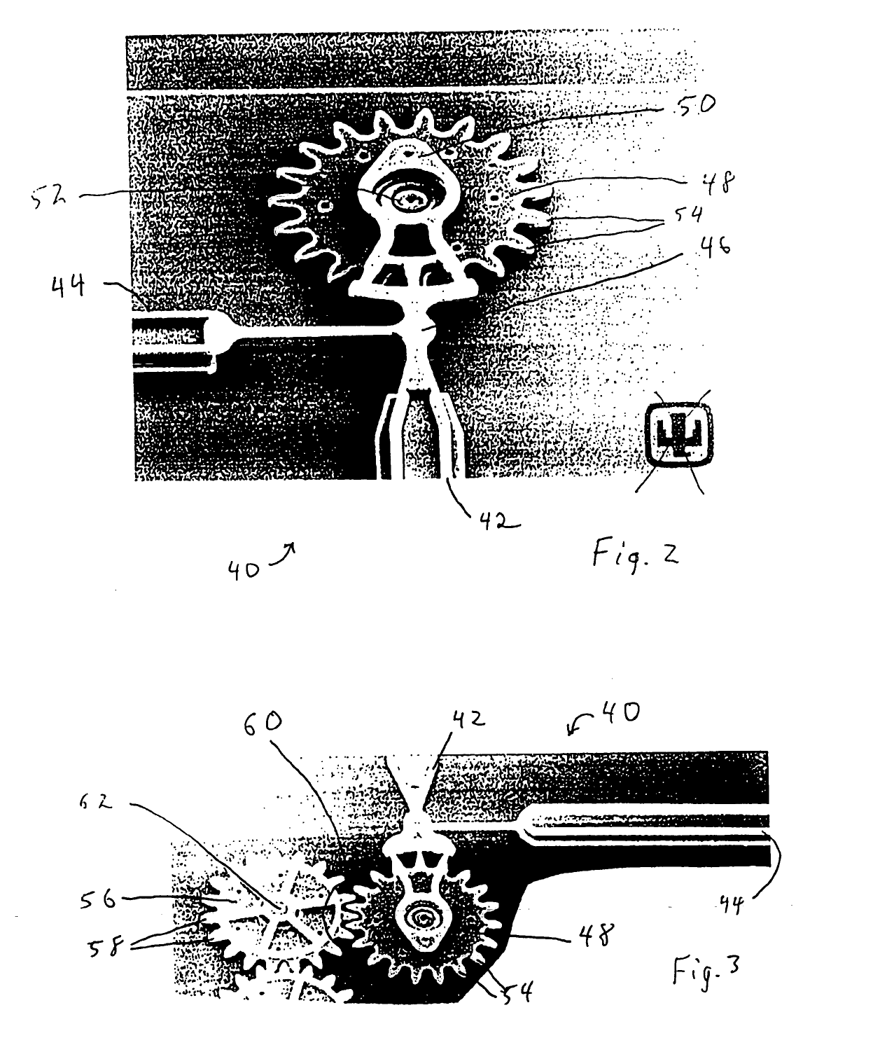

FIG. 2 shows an enlarged perspective view of the type of drive gear shown in FIG. 1. Drive arm 42 attaches to drive gear 48 at connection point 50. Cam rod 44 attaches to drive arm 42 at connection point 46. By the motion described above, drive gear 48 is rotated about its axis 52. This allows its teeth 54 to interact with other gears, thereby conferring rotational motion.

FIG. 3 is another view of the drive gear. In this figure, drive gear 48 actuates load gear 56 by virtue of the meshing of the teeth 54 and 58, respectively, at its mesh point 60. Load gear 56 rotates about its axis 62. In this figure, the load gear does not have a nanotool attached. As is explained below, to attach a nanotool, a platform is formed on the top of load gear 56 and would normally block the view of axis 62.

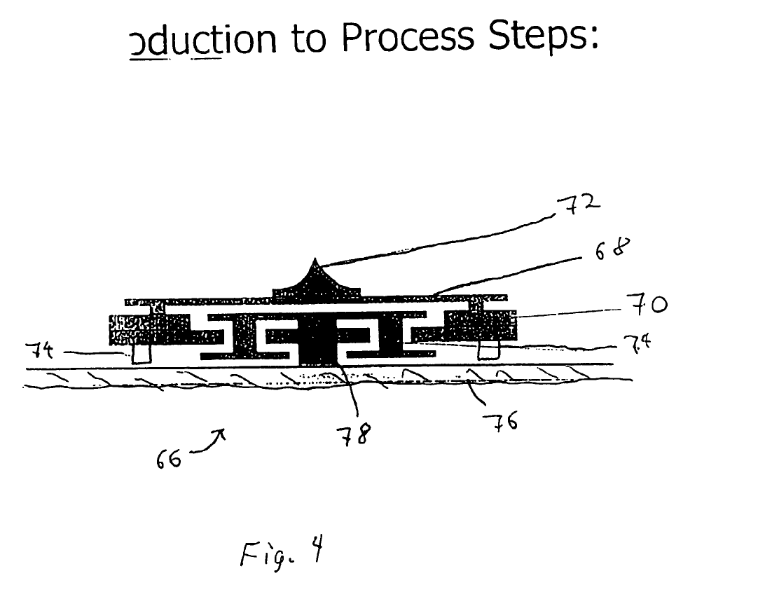

FIG. 4 shows a cross-section of a typical nanotool on a micro gear. Gear 70 rotates about hub 78. Platform 68 is fabricated onto gear 70 and does not contact hub 78. Nanotool 72 is fabricated on top of platform 68 and is aligned with the axis of the gear 70. Nanotool 72 rotates at the same speed as gear 70. In this particular embodiment, nanotool 72 is a nano drill. Device 60, comprising a nanotool fabricated upon a platform that is attached to load gear 70, is fabricated by processes well known in the art of nano technology. Such objects may be readily manufactured at Sandia National Laboratory or other microfabrication labs. Load gear 70 also has dimples 74 located on its bottom. Dimples 74 minimize the amount of tilting of gear 70. Tilting of gear 70 is generally undesirable as it reduces the accuracy of nanotool 72. Of course, those skilled in the art will appreciate that in some situations, tilting of gear 70 and resulting tilting of platform 68 and nanotool 72, may be desirable in some situations. A nanotool that pivots slightly as it rotates may facilitate the formation of relatively large structures such as reservoirs.

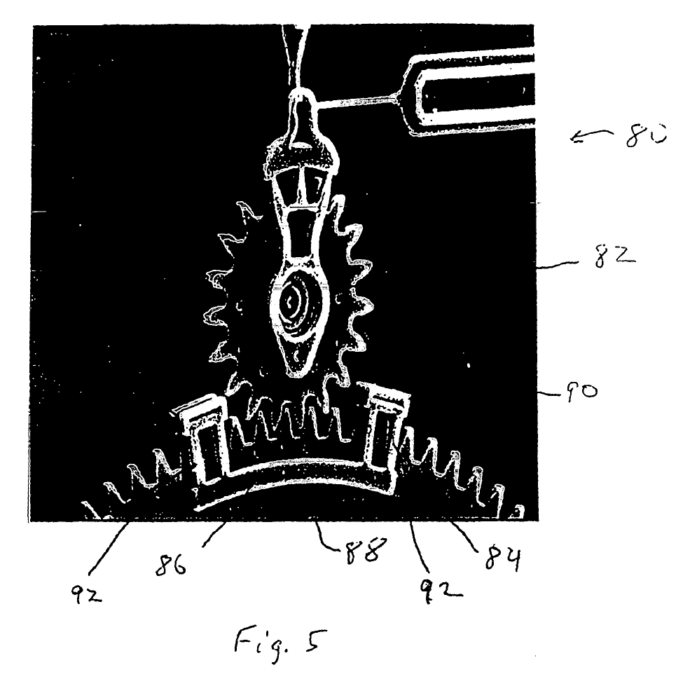

FIG. 5 shows a perspective view of micromotor 80. Drive gear 82 interlocks with load gear 84 and causes it to rotate. FIG. 5 shows a clamp 88 that may be used in combination with or in place of the dimples shown in FIG. 4. Clamp 88 is comprised of posts 90, bracket 86 and clamp rods 92. Clamp 88 helps to hold load gear 84 in a steady position and minimize tilting.

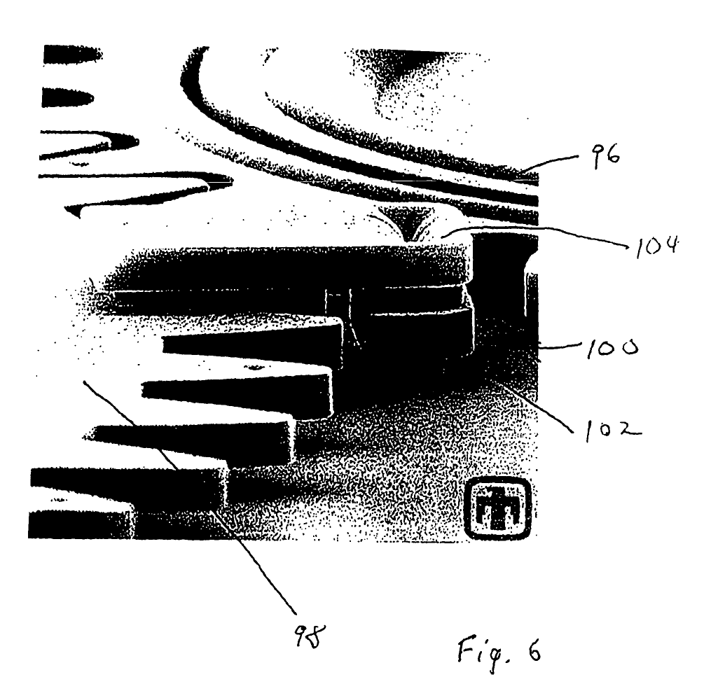

FIG. 6 shows an alternative design of a bracket 100. Bracket 100 consists of posts 102 and arm 104 that help to hold load gear 98 in place and minimize tilting as it is rotated by drive gear 96.

When removing material, nanotools may perform a variety of functions. Micromachined nanodevices that are processed by the invention must have very flat surfaces and be highly polished. Nanotools such as the one illustrated in FIG. 7 are known as a burring or polishing nanotool 110. Attachment end 116 of stem 118 may be attached to a base of a nanotool or to a microgear. Bit 122 is located at the opposite end of stem 118. When the micromotor is activated and the tool rotates, bit 122 forms a polished surface on substrate 112. Surface 114 of substrate 112 has been treated with the burring nanotool 110 and is smooth and polished. Surface 120 of substrate 112 has not been treated with nanotool 110 and is rough. Those skilled in the art of nanotechnology will appreciate the importance of substrates having a smooth, polished surface. Nanotools such as the one shown here in FIG. 7 are also useful for polishing surfaces to used for nanoscale optical systems.

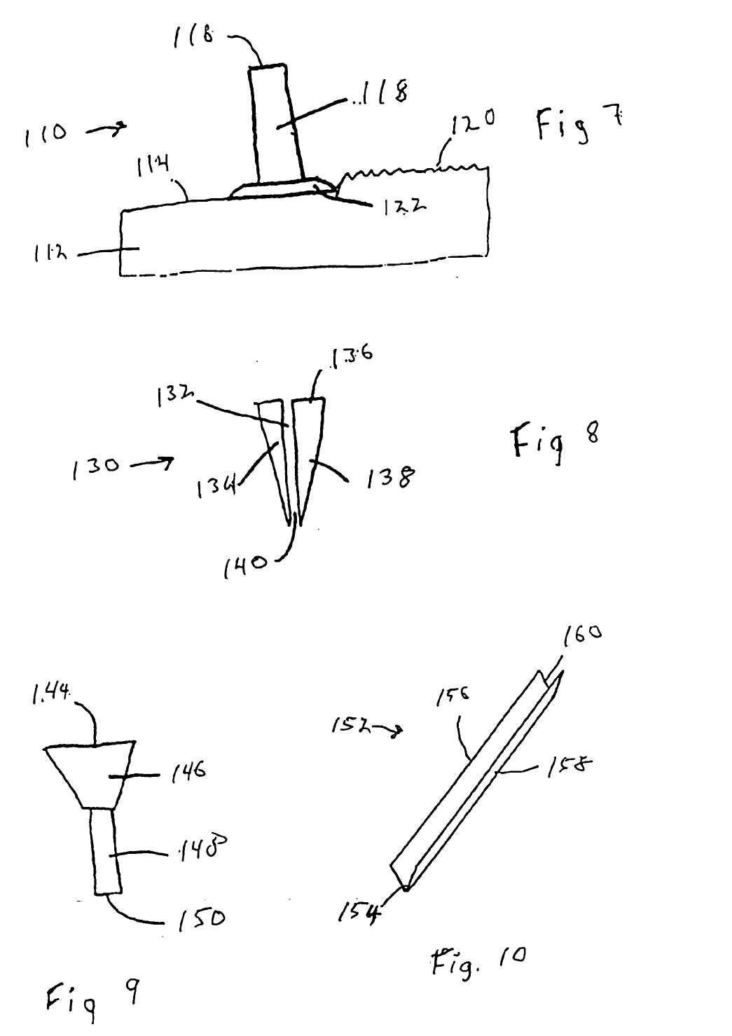

FIG. 8 illustrates the cross section of a pen or deposition nanotool 130. Attachment end 136 attaches to either a base, a microgear or a microplatform. Side walls 134 and 138 form tube 132 that carries the deposition material to the substrate. Deposition material exits nanotool 130 at the tip 140 where it is deposited onto the substrate. The deposition material may be either liquid or solid. Often, the deposition material is a liquid that will harden after deposition. Hardening may or may not require a chemical treatment or firing. Electrically conductive ink is an example of such a material. Those skilled in the art will appreciate that there are a wide variety of deposition materials that it would be desirable to apply to a nanoscale substrate. Nanotools such as the one shown in FIG. 8 may deposit bands of material that are only a few nanometers in width. The rotational motion of a microgear may be used to pump the deposition material down channel 132. A microgear may be separately attached to a nanopump, or the channel 132 may be designed in such a way that rotation of the nanotool 130 itself causes the deposition material to be drawn through the channel 132. Those skilled in the art will appreciate that rotational motion has been used ubiquitously to pump liquids.

FIG. 9 shows an alternative embodiment of the invention. Base 146 attaches to a microgear, or a microplatform, at attachment end 144. Stem 148 and end 150 may be either smooth or rough. End 150 may be flat, as shown, or pointed. Nanotool 142 may be used as either a hole punching nanotool or as a drill. If the nanotool is to be used as a drill, then both stem 148 and end 150 are preferably rough, perhaps coated with nano crystalline diamond. If the nanotool is to be used as a hole puncher, then rotational motion is not required. Stem 52 is preferably smooth, and end 54 is preferably pointed.

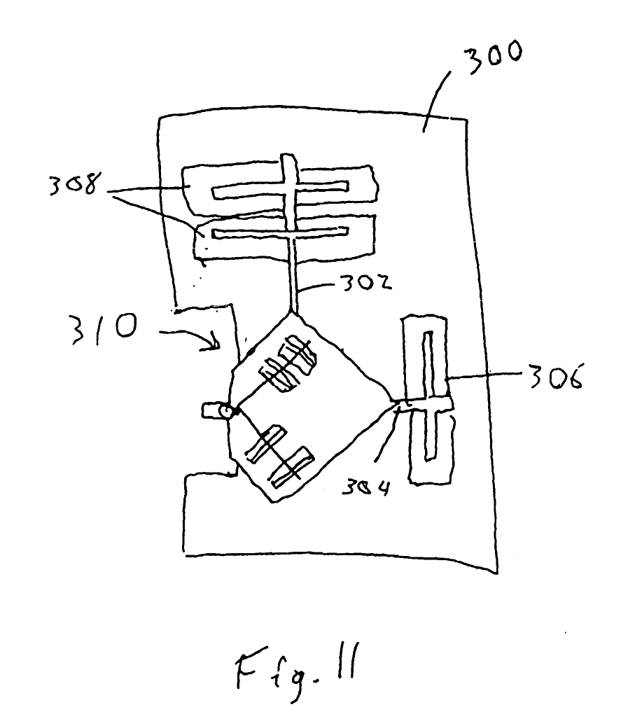

FIG. 10 shows a nanotool 152 that may be used to form channels or vias in the substrate. It has two sides 156 and 158 that meet at an angle such that the nanotool has a “V” shaped cross section. End 160 is attached to a base, directly to a microgear or a microplatform. Scraping end 154 is applied to the substrate and either the substrate or the tool is moved in the direction of the desired channel. Those skilled in the art will appreciate that there are a variety of uses for channels in nanoscale substrates. While the nanotool shown here has a “V” shaped cross section, those skilled in the art will appreciate that other cross section shapes, such as “U” shaped or rectangular may be more desirable depending on the purpose of the channel.

As with the other nanotools, this nanotool may be 100 nanometers or less in width, and from a few hundred nanometers to a few micrometers in length.

Nanotools may also be comprised of an optic fiber that transmits a laser to the nanoscale substrate. In addition, nanotools may also be comprised of evaporators and heat transfer devices to melt, dry or deposit materials on the substrate. Some heat transfer devices may be comprised of a nanotool which is itself, its base or its platform in physical contact with a heating element. This heating element transfers heat to the nanotool which subsequently transfers heat to the nanostructure being fabricated. Nanotools may also be used for dip-pen writing as described above and may also be comprised of a stamping device. Cutting or saw type of nanotools may also be used to form trenches, channels, vias and the like in the substrate, or to cut completely through the substrate. Nanotools may also be comprised of an electrode in order to apply current to the substrate. Stamping tools, that stamp indentions into, stamp materials onto, or both, may also be used. While drawings of these tools are not provided, such processes are well known to those skilled in the art. However, they have not previously been effectively performed at this scale prior to the present invention. It is often desirable to reduce stiction by coating a nanotool with a self-assembled monolayer (SAM's) of lipids or other coatings known in the art.

Nanotools may be comprised of a variety of materials. Silicon may be used, and silicon that has been doped with Indium or Gallium by applying a focused ion beam to the nanotool are often preferable because they have a more precise shape and are generally stronger. It is often desirable to use a chemical, such as silicon, tungsten filaments, carbon fibers and the like, that may be easily shaped to form a frame for the nanotool, and then to coat the nanotool with a chemical or material better suited to the desired function of the nanotool. Alloys of titanium and nickel, diamond like carbon and nano crystalline diamond are all good coating materials. Gallium Arsenide is another desirable coating material. A variety of other materials suitable for forming the frame and for coating are well know to those skilled in the art.

Focused Ion Beam (FIB) technology is preferably used to form the nanotools. FIB and/or known wet-etching techniques may be used to precisely etch the shape of the nanotool In addition, FIB may be used to deposit materials directly on a microgear or microplatform to form the nanotool. This provides precise formation of the nanotool.

Other methods of fabricating these nanotools known to those in the art are also suitable. These methods include femtosecond laser techniques, electron beam techniques and the like.

It may be desirable to use additional actuators to combine linear and rotational motion. FIG. 11 shows such a combination. Microplatform 310 is be attached to linear drive rods 302 and 304. Drive rods 302 and 304 are powered by electrostatic combs 308 and 306 respectively. This allows nanotools driven by rotation, such as drills and the like, to machine the same nanoscale substrate at several points on the substrate rapidly without having to reposition the substrate.

Whereas, the present invention has been described in relation to the drawings attached hereto, it should be understood that other and further modifications, apart from those shown or suggested herein, may be made within the spirit and scope of this invention.

1. A micro and nano mechanical machining device comprising:
a rotatable load gear;
a micro-motor; and,
a nanotool attached to said micro-gear,
wherein said micro-motor engages and actuates said micro-gear thereby causing said micro-gear and said nanotool to rotate.

2. The device of claim 1 wherein said micromotor is powered by at least one of the group consisting of an electrostatic comb, a micro-scale steam engine, piezoelectric mechanism, piezoresistive mechanism or a thermal actuator.

3. The device of claim 1 wherein said tool is selected from the group consisting of a drill, a deburr, a miller, a hole puncher, a stamp, a pen, a heater or an evaporator.

4. The device of claim 1 wherein said tool is formed by application of at least one of the group consisting of a focused ion beam, photolithography or laser.

5. The device of claim 1 wherein said nanotool is surface engineered by being coated with metals, ceramics, polymers, liquids, composites, titanium, nickel, gallium arsenide, polyamide, silicon or multilayered titanium nitride and titanium aluminum nitride.

6. The micromachining device of claim 1 wherein said nanotool is coated with diamond like carbon.

7. The micromachining device of claim 1 wherein said nanotool is coated with nano crystalline diamond.

8. The micromachining device of claim 1 wherein said tool is comprised of silicon.

9. The micromachining device of claim 8 wherein said tool is further comprised of at least one element from the group consisting of gallium or indium.

10. The micromachining device of claim 1 wherein said nanotool is less than one micrometer wide.

11. The micromachining device of claim 10 wherein said nanotool is less than 100 nanometers wide.

12. A method for machining a nanoscale substrate comprising:
engaging a load gear with a micromotor such that said micromotor actuates said load gear thereby causing said load gear to rotate,
engaging said substrate with a nanotool, said nanotool being attached to said load gear;
actuating said load gear with said micro-motor thereby causing said nanotool to rotate.

13. The method for machining a nanoscale substrate of claim 12 wherein said tool is selected from the group consisting of a drill, a deburrer, a miller, a hole puncher, a stamp or a pen.

14. A method for fabricating a micromachining device comprising:
depositing a nanotool onto a microgear;
engaging said microgear to a micromotor such that said micromotor may rotatable actuate said microgear thereby rotating said nanotool.
